(19) United States
(12) Patent Application Publication
(10) Pub. No.: US 2021/0303868 A1
(43) Pub. Date: Sep. 30, 2021

(54) ELECTRONIC APPARATUS AND METHOD FOR CONTROLLING ELECTRONIC APPARATUS

(71) Applicant: Samsung Electronics Co., Ltd., Suwon-si, Gyeonggi-do (KR)

(72) Inventor: Haedong YEO, Suwon-si (KR)

(21) Appl. No.: 17/266,720

(22) PCT Filed: Jun. 24, 2019
(86) PCT No.: PCT/KR2019/007601

§ 371 Date: Feb. 8, 2021

(30) Foreign Application Priority Data
Sep. 13, 2018 (KR) 10-2018-0109686
Oct. 10, 2018 (KR) 10-2018-0120593

(51) Int. Cl. G06K 9/00; G06F 3/00; D06F 73/02; G06N 3/08; G06F 16/9537; G06F 16/583

(52) U.S. Cl. CPC G06K 9/00771; G06F 3/005; G06F 16/583; G06N 3/08; G06F 16/9537; D06F 73/02

(57) ABSTRACT

Provided is an electronic apparatus including a body for providing a process room where clothes are placed, a heater for supplying at least one of hot air and steam into the process room, at least one camera for photographing an inside of the process room, a display, a processor, and a memory, wherein the memory stores instructions to be executed by the processor to control the camera to generate a first clothing image by photographing first clothing introduced into the process room, obtain information about the first clothing by using the first clothing image, obtain information about second clothing matching the first clothing by using the information about the first clothing, control the display to display the obtained information about the second clothing, and obtain and display information about second clothing different from the displayed second clothing in response to a user input for changing a second clothing recommendation condition. When the information about the second clothing is estimated, the electronic apparatus may use a rule-based or artificial intelligence (AI) algorithm. When the information about the second clothing is estimated using the AI algorithm, the electronic apparatus may use a machine learning, neural network, or deep learning algorithm.

### TECHNICAL FIELD

The disclosure relates to an electronic apparatus for recommending clothing, and a method of controlling the electronic apparatus to recommend clothing.

The disclosure also relates to an artificial intelligence (AI) system using a machine learning algorithm (e.g., a deep learning algorithm), and applications thereof.

### BACKGROUND ART

Electronic apparatuses for taking care of clothes are currently used to eliminate dust or odors from clothes and reduce wrinkles of the clothes.

Such an electronic apparatus includes a body including a process room where clothes are placed and taken care of, and a door for opening or closing the process room. The body may include an air blower for supplying air or hot air to the clothes, and a steam generator for supplying steam to the clothes.

Therefore, the electronic apparatus may perform a function of eliminating dust or odors from the clothes by supplying air or hot air generated by the air blower to the clothes and a function of smoothing wrinkles of the clothes by supplying steam generated by the steam generator.

Currently, artificial intelligence (AI) systems capable of implementing human-level intelligence have been used in various fields. AI systems refer to systems in which a machine autonomously learns, makes determinations, and becomes smarter unlike existing rule-based smart systems. Because a recognition rate is increased and user preferences are more accurately understood in proportion to the number of iterations of the AI systems, the existing rule-based smart systems have been gradually replaced by deep-learning-based AI systems.

AI technology includes machine learning (e.g., deep learning), and element technologies using the machine learning.

The machine learning is an algorithm technology for autonomously classifying/learning features of input data, and the element technologies are technologies for mimicking functions, e.g., recognition and determination, of human brains by using the machine learning algorithm such as deep learning, and include technical fields such as linguistic understanding, visual understanding, inference/prediction, knowledge representation, operation control, etc.

Various fields using AI technology are as described below. The linguistic understanding is a technology for recognizing and applying/processing human languages/characters, and includes natural language processing, machine translation, dialog systems, queries and responses, speech recognition/synthesis, etc. The visual understanding is a technology for recognizing and processing objects like human vision, and includes object recognition, object tracking, image search, human recognition, scene understanding, space understanding, image enhancement, etc. The inference/prediction is a technology for determining information and logically performing inference and prediction, and includes knowledge/probability-based inference, optimization prediction, preference-based planning, recommendation, etc. The knowledge representation is a technology for automating human experience information into knowledge data, and includes knowledge construction (e.g., data generation/classification), knowledge management (data utilization), etc. The operation control is a technology for controlling autonomous driving of vehicles or motion of robots, and includes motion control (e.g., navigation, collision avoidance, and driving control), manipulation control (e.g., action control), etc.

### DESCRIPTION OF EMBODIMENTS

### Technical Problem

Provided is a method of recommending clothing suitable to wear with clothing taken care of by using an electronic apparatus.

In addition, provided is a method of recommending clothing suitable to wear with clothing taken care of by using an electronic apparatus by reflecting a clothing regional trend.

### Solution to Problem

According to an embodiment, an electronic apparatus includes a body for providing a process room where clothes are placed, a heater for supplying at least one of hot air and steam into the process room, at least one camera for photographing an inside of the process room, a display, a processor, and a memory, wherein the memory stores instructions to be executed by the processor to control the camera to generate a first clothing image by photographing first clothing introduced into the process room, obtain information about the first clothing by using the first clothing image, obtain information about second clothing matching the first clothing by using the information about the first clothing, control the display to display the obtained information about the second clothing, and obtain and display information about second clothing different from the displayed second clothing in response to a user input for changing a second clothing recommendation condition.

The information about the first clothing and the information about the second clothing may include at least one of a representative image of clothing, a type of clothing, a brand of clothing, or a color of clothing.

The instructions may be executed by the processor to identify the second clothing matching the first clothing by using a clothing trend database stored in the electronic apparatus, and obtain information about the identified second clothing.

The clothing trend database may be generated using at least one of clothing images or clothing data included in online fashion magazines, clothing images or clothing data included in social media, and images obtained using closed-circuit televisions (CCTVs) located in various regions.

The instructions may be executed by the processor to obtain the second clothing recommendation condition by clustering data stored in the clothing trend database.

The electronic apparatus may further include a communication module, and the instructions may be executed by the processor to control the communication module to obtain weather information, and change and display the second clothing in response to a user input for applying the weather information as the second clothing recommendation condition.

The electronic apparatus may further include a communication module, and the instructions may be executed by the processor to control the communication module to obtain schedule information of a user, and change and display the second clothing in response to a user input for applying the schedule information as the second clothing recommendation condition.

The instructions may be executed by the processor to obtain the information about the second clothing matching the first clothing by using clothing images previously captured and stored using the camera.

The instructions may be executed by the processor to display an image including clothing equal or similar to the first clothing, and an image including the second clothing.

According to another embodiment, a server includes a communication module, a processor, and a memory, wherein the memory stores instructions to be executed by the processor to obtain information about first clothing through the communication module from an external apparatus, obtain information about second clothing matching the first clothing by applying the information about the first clothing to a clothing trend database, and control the communication module to transmit the information about the second clothing to the external apparatus.

According to another embodiment, a method of controlling an electronic apparatus includes generating a first clothing image by photographing first clothing, obtaining information about the first clothing by using the first clothing image, obtaining information about second clothing matching the first clothing by using the information about the first clothing, displaying the information about the second clothing, and obtaining and displaying information about second clothing different from the displayed second clothing in response to a user input for changing a second clothing recommendation condition.

The method may further include identifying the second clothing matching the first clothing by using a clothing trend database stored in the electronic apparatus, and obtaining information about the identified second clothing.

The clothing trend database may be generated using at least one of clothing images or clothing data included in online fashion magazines, clothing images or clothing data included in social media, and images obtained using closed-circuit televisions (CCTVs) located in various regions.

The method may further include obtaining the second clothing recommendation condition by clustering data stored in the clothing trend database.

The method may further include obtaining weather information, and changing and displaying the second clothing in response to a user input for applying the weather information as the second clothing recommendation condition.

The method may further include obtaining schedule information of a user, and changing and displaying the second clothing in response to a user input for applying the schedule information as the second clothing recommendation condition.

The method may further include obtaining the information about the second clothing matching the first clothing by using clothing images previously captured and stored using a camera included in the electronic apparatus.

The method may further include displaying an image including clothing equal or similar to the first clothing, and an image including the second clothing.

According to another embodiment, a method of controlling a server includes obtaining information about first clothing from an external apparatus, obtaining information about second clothing matching the first clothing by applying the information about the first clothing to a clothing trend database, and transmitting the information about the second clothing to the external apparatus.

According to another embodiment, an electronic apparatus includes a camera, a display, at least one processor for executing one or more instructions, and at least one memory for storing the one or more instructions, wherein the at least one processor executes the one or more instructions to control the camera to generate a first clothing image by photographing first clothing, estimate information about second clothing matching the first clothing by applying the first clothing image to a trained model, control the display to display the information about the second clothing, and obtain and display information about second clothing different from the displayed second clothing in response to a user input for changing a second clothing recommendation condition, and wherein the trained model may be a model trained using, as training data, clothing images and information about regions where the clothing images are captured.

### Advantageous Effects of Disclosure

An electronic apparatus according to an embodiment of the disclosure may recommend a user for clothing suitable to wear with clothing taken care of by using the electronic apparatus.

The electronic apparatus according to an embodiment of the disclosure may recommend a user for clothing suitable to wear with clothing taken care of by using the electronic apparatus by reflecting a clothing regional trend.

### BRIEF DESCRIPTION OF DRAWINGS

FIG. 1 is a diagram for describing a situation of recommending clothing by using an electronic apparatus according to an embodiment.

FIG. 2 is a block diagram of an electronic apparatus according to an embodiment.

FIG. 3 is a diagram for describing another situation of recommending clothing by using an electronic apparatus according to an embodiment.

FIG. 4 is a diagram for describing a situation of using weather information to recommend clothing by using an electronic apparatus according to an embodiment.

FIG. 5 is a diagram for describing a situation of using color information to recommend clothing by using an electronic apparatus according to an embodiment.

FIG. 6 is a diagram for describing a situation of using a personal schedule of a user to recommend clothing by using an electronic apparatus according to an embodiment.

FIG. 7 is a flowchart for describing a situation where an electronic apparatus according to an embodiment recommends clothing.

FIG. 8 is a flowchart for describing a situation where an electronic apparatus according to an embodiment recommends clothing by using a server.

FIG. 9 is a perspective view of an electronic apparatus according to an embodiment.

FIG. 10 is a side cross-sectional view of an electronic apparatus according to an embodiment.

FIG. 11 is a block diagram of a processor according to an embodiment.

FIG. 12 is a schematic diagram of another electronic apparatus according to an embodiment.

### MODE OF DISCLOSURE

Hereinafter, various embodiments of the disclosure will be described in detail with reference to the attached drawings. The disclosure may, however, be embodied in many different forms and should not be construed as being limited to specific embodiments set forth herein; rather, these embodiments covers various modifications, equivalents and/or alternatives thereof. In the drawings, like reference numerals denote like elements.

As used herein, the expression “have”, “may have”, “include”, “may include”, “comprise”, or “may comprise” indicates the presence of a feature (e.g., a numerical value, a function, an operation, or an element such as a component) and does not exclude the presence of an additional feature.

The expression “A or B”, “at least one of A or/and B”, or “one or more of A or/and B” may include all possible combinations of the listed items. For example, “A or B”, “at least one of A and B”, or “at least one of A or B” may refer to all cases in which (1) at least one A is included, (2) at least one B is included, and (3) at least one A and at least one B are both included.

The expressions such as “first”, “second”, “1st”, and “2nd” used herein may refer to various different elements irrespective of the order and/or priority thereof, and are merely used to distinguish one element from another without limiting the elements. For example, “a first user device” and “a second user device” may indicate different user devices irrespective of the order or priority thereof. Specifically, a first element may be referred to as a second element and, similarly, a second element may be referred to as a first element without departing from the scope of the disclosure.

As used herein, the term “module”, “unit”, or “part” denotes an entity for performing at least one function or operation, and may be implemented as hardware, software, or a combination of hardware and software. A plurality of “modules”, “units”, or “parts” may be integrated into at least one module or chip and be implemented by at least one processor, except for a case where they need to be implemented as individual specific hardware components.

It will be understood that, when an element (e.g., a first element) is referred to as being “(operatively or communicatively) coupled with/to” or “connected to” another element (e.g., a second element), the element can be coupled or connected to the other element directly or through another element (e.g., a third element). On the contrary, it will be understood that, when an element (e.g., a first element) is referred to as being “directly coupled to” or “directly connected to” another element (e.g., a second element), another element (e.g., a third element) is not present therebetween.

Terms used herein are merely used to describe specific embodiments of the disclosure, and are not intended to limit the scope of other embodiments of the disclosure. Singular forms are intended to include plural forms as well, unless the context clearly indicates otherwise. All terms (including technical and scientific terms) used herein have the same meaning as generally understood by one of ordinary skill in the art. Terms as defined in a commonly used dictionary should be construed as having the same meaning as in an associated technical context, and unless clearly defined herein, the terms are not ideally or excessively construed as having formal meaning. In some cases, even terms defined in this specification cannot be construed to exclude embodiments of the disclosure.

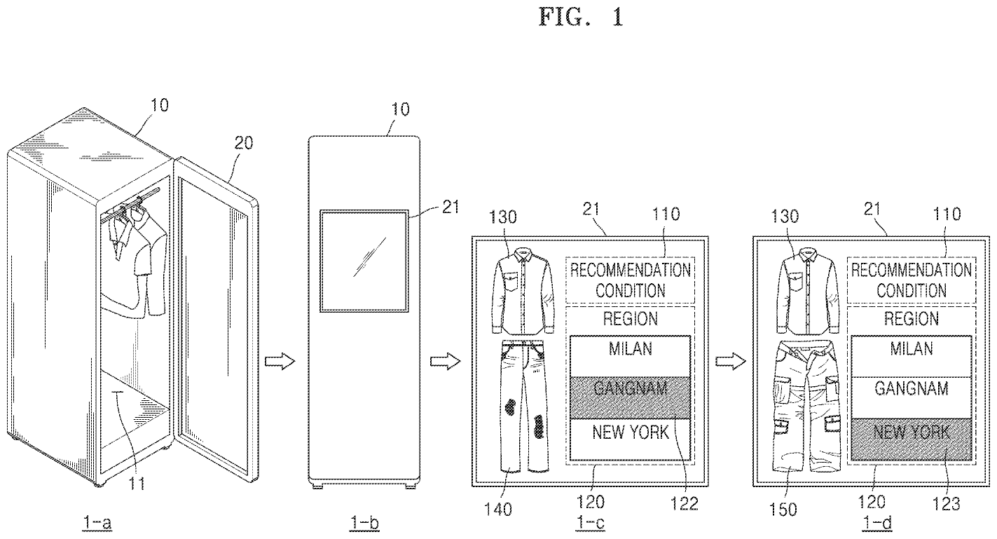

FIG. 1 is a diagram for describing a situation of recommending clothing by using an electronic apparatus 10 according to an embodiment.

Referring to FIG. 1, the electronic apparatus 10 may include a clothing care system for eliminating dust or odors from clothes and reducing wrinkles of the clothes. However, the electronic apparatus 10 is not limited thereto. For example, the electronic apparatus 10 may be implemented as an apparatus including a memory and a processor. For example, the electronic apparatus 10 may be implemented as various apparatuses such as a mobile phone, a smartphone, a tablet personal computer (PC), a digital camera, a camcorder, a laptop computer, a tablet PC, a desktop computer, an e-book reader, a digital broadcast receiver, a personal digital assistant (PDA), a portable multimedia player (PMP), an MP3 player, and a wearable device.

According to an embodiment, the electronic apparatus 10 may provide a required service to a user by using an application (or an application program) stored therein (e.g., a gallery application or a web browser application).

According to an embodiment, the electronic apparatus 10 may have established communication with another electronic apparatus (e.g., a mobile phone, a smartphone, or a tablet PC) by using communication modules included in the electronic apparatus 10 and the other electronic apparatus. The electronic apparatus 10 may establish communication with the other electronic apparatus directly or via a third apparatus (e.g., a gateway or a home server).

According to an embodiment, the electronic apparatus 10 may establish a communication network by using a wired or wireless communication method. The electronic apparatus 10 may include a wireless communication module (e.g., a cellular communication module, a short-range wireless communication module, or a global navigation satellite system (GNSS) communication module) or a wired communication module (e.g., a local area network (LAN) communication module or a power line communication module), and communicate with the other electronic apparatus by using an appropriate communication module through a first network (e.g., a short-range wireless communication network such as Bluetooth, WiFi direct, or Infrared Data Association (IrDA)) or a second network (e.g., a telecommunication network such as a cellular network, the Internet, or a computer network (e.g., a local area network (LAN) or a wide area network (WAN))).

Reference Numeral 1-a of FIG. 1 is a perspective view showing that a door 20 of the electronic apparatus 10 is open.

Referring to Reference Numeral 1-a of FIG. 1, a user may open the door 20 of the electronic apparatus 10 and place various types of clothes in a process room 11. According to an embodiment, clothes or clothing may refer to items made of fabric, leather, etc. to cover or protect a part of a human body. The electronic apparatus 10 may perform a clothing care operation for reducing wrinkles and eliminating odors of the clothes inside the process room 11.

The electronic apparatus 10 may photograph the clothes in the process room 11 by using at least one camera (not shown) capable of photographing the process room 11. For example, the electronic apparatus 10 may generate a first clothing image by photographing first clothing in the process room 11 by using the camera. The first clothing may refer to, for example, one of various types of clothes such as shirts, jackets, jeans, cotton pants, short pants, and coats, etc.

The electronic apparatus 10 may obtain information about the first clothing by using the generated first clothing image.

The information about the first clothing may include at least one of, for example, a representative image of the first clothing, a type of the first clothing, a brand of the first clothing, or a color of the first clothing. The electronic apparatus 10 may obtain the information about the first clothing by using, for example, a clothing trend database to be described below. Alternatively, the electronic apparatus 10 may obtain the information about the first clothing by using, for example, online search.

The representative image may be, for example, the first clothing image generated by photographing the first clothing. Alternatively, the representative image may be an image obtained online by the electronic apparatus 10 based on the type or brand of the first clothing.

Referring to Reference Numeral 1-b of FIG. 1, the electronic apparatus 10 may include a display 21. For example, the display 21 may be located on the door 20 of the electronic apparatus 10. The display 21 may include a touchscreen display. However, the location of the display 21 is not limited thereto. The electronic apparatus 10 may display information related to clothes by using the display 21. For example, the user may control operation of the electronic apparatus 10 by selecting an execution object (not shown) displayed on the display 21.

According to an embodiment, the electronic apparatus 10 may recommend clothing to the user by using the display 21. For example, the electronic apparatus 10 may obtain the information about the first clothing as described above in relation to Reference Numeral 1-a of FIG. 1. Then, the electronic apparatus 10 may obtain information about second clothing matching the first clothing by using the information about the first clothing. The second clothing may refer to, for example, one of various types of clothes such as shirts, jackets, jeans, cotton pants, short pants, and coats, etc.

The information about the second clothing may include at least one of, for example, a representative image of the second clothing, a type of the second clothing, a brand of the second clothing, or a color of the second clothing. The electronic apparatus 10 may obtain the information about the second clothing by using, for example, the clothing trend database to be described below. Alternatively, the electronic apparatus 10 may obtain the information about the second clothing by using, for example, online search.

The representative image may be, for example, a second clothing image generated by photographing the second clothing. Alternatively, the representative image may be an image obtained online by the electronic apparatus 10 based on the type or brand of the second clothing.

The obtaining of the information about the second clothing matching the first clothing may refer to, for example, identifying the second clothing as clothing suitable for the user to wear with the first clothing, and obtaining information about the second clothing. Alternatively, the obtaining of the information about the second clothing matching the first clothing may refer to, for example, identifying the second clothing as clothing that the user is highly likely to wear with the first clothing, and obtaining information about the second clothing. Alternatively, the obtaining of the information about the second clothing matching the first clothing may refer to, for example, identifying the second clothing as clothing which is included in a preset or larger number of images including the first clothing, and obtaining information about the second clothing. Alternatively, the obtaining of the information about the second clothing matching the first clothing may refer to, for example, identifying the second clothing as clothing which is mentioned a preset or larger number of times together with the information about the first clothing, and obtaining information about the second clothing.

According to an embodiment, the electronic apparatus 10 may obtain the information about the second clothing matching the first clothing, by using the clothing trend database. The clothing trend database may be generated using at least one of clothing images or clothing data included in online fashion magazines, clothing images or clothing data included in social media, or pedestrian images obtained using closed-circuit televisions (CCTVs) located in various regions. However, the clothing trend database is not limited thereto. The clothing trend database may include various types of data related to clothes.

According to an embodiment, the clothing trend database may cluster collected data. As such, the clothing trend database may classify or group the collected data into various groups. The electronic apparatus 10 may identify the second clothing matching the first clothing, by using the classified and grouped clothing trend database.

According to various embodiments, the clothing trend database may be configured per user. For example, the electronic apparatus 10 may use clothes owned by the user, for the clothing trend database. For example, the electronic apparatus 10 may reflect, to the clothing trend database, clothing images previously captured using the camera included in the electronic apparatus 10. Alternatively, the electronic apparatus 10 may configure the clothing images previously captured using the camera included in the electronic apparatus 10, as an additional database to be referred by the electronic apparatus 10 when the electronic apparatus 10 uses the clothing trend database to obtain the information about the second clothing. Alternatively, the electronic apparatus 10 may add preference of the user for clothes, which is obtained using information found by the user to purchase clothes or information about clothes stored in a shopping list, to the additional database.

The clothing trend database may be periodically updated. The clothing trend database may be stored in, for example, a memory of the electronic apparatus 10 or an external server.

Referring to Reference Numeral 1-c of FIG. 1, the electronic apparatus 10 may display the information about the second clothing on the display 21. For example, the electronic apparatus 10 may display the representative image of the second clothing on the display 21 as the information about the second clothing.

According to an embodiment, the electronic apparatus 10 may display, on the display 21, a recommendation condition 110 for obtaining the information about the second clothing. The recommendation condition 110 for obtaining the information about the second clothing may include at least one of, for example, a region where clothing is mainly consumed, a race, a color of clothing, a type of clothing, a brand of clothing, clothes owned by the user, and an age group who prefers clothing.

However, the recommendation condition 110 for obtaining the information about the second clothing is not limited thereto. For example, the electronic apparatus 10 may newly generate or delete the recommendation condition 110 by clustering data included in the clothing trend database. For example, the electronic apparatus 10 may generate or delete the recommendation condition 110 by using the classified or grouped various groups of the clothing trend database. Alternatively, the electronic apparatus 10 may generate the recommendation condition 110 based on personal preference of the user. Alternatively, the electronic apparatus 10 may generate the recommendation condition 110 as a condition input by the user.

According to various embodiments, when a region is used as the recommendation condition 110, the electronic apparatus 10 may check social media sites and use clothing images posted on the social media sites in the region. Alternatively, when a region is used as the recommendation condition 110, the electronic apparatus 10 may check online fashion magazines and use clothing images of the online fashion magazines issued in the region.

Referring to Reference Numeral 1-c of FIG. 1, the electronic apparatus 10 may identify the second clothing matching the first clothing by setting “Gangnam” 122 as a region 120 used as a recommendation condition 110. The electronic apparatus 10 may identify the second clothing matching a shirt 130 corresponding to the first clothing by using images captured by CCTVs in Gangnam. For example, the electronic apparatus 10 may identify jeans 140 as the second clothing matching the shirt 130 corresponding to the first clothing, and obtain and display information about the jeans 140 on the display 21.

According to an embodiment, the electronic apparatus 10 may identify the second clothing as the jeans 140 which are included in a large number of images including the shirt 130 corresponding to the first clothing, and obtain and display the information about the second clothing on the display 21. In this case, for example, the electronic apparatus 10 may identify the second clothing as the jeans 140 which are included in a large number of images including the shirt 130 corresponding to the first clothing, and display the jeans 140 on the display 21 from among clothing images previously captured and stored by the electronic apparatus 10 by photographing the clothes owned by the user.

According to various embodiments, when the clothing trend database is stored in the external server, the electronic apparatus 10 may transmit the first clothing image to the server. The server may obtain the information about the first clothing by using the first clothing image and transmit the obtained information to the electronic apparatus 10.

According to various embodiments, when the clothing trend database is stored in the external server, the electronic apparatus 10 may transmit the first clothing image to the server. The server may obtain the information about the first clothing by using the first clothing image, and obtain the information about the second clothing matching the first clothing by using the obtained information about the first clothing The electronic apparatus 10 may receive the information about the second clothing from the server and display the received information.

According to an embodiment, the electronic apparatus 10 may change and display the second clothing in response to a user input for changing the recommendation condition 110. The changing and displaying of the second clothing may refer to, for example, newly identifying second clothing matching the first clothing to replace the previously identified second clothing, and obtaining and displaying information about the newly identified second clothing.

Referring to Reference Numeral 1-d of FIG. 1, the electronic apparatus 10 may receive a user input for changing the region 120 to “New York” 123. The electronic apparatus 10 may change the information about the previously identified second clothing based on the changed recommendation condition 110. For example, the electronic apparatus 10 may identify the second clothing matching the shirt 130 corresponding to the first clothing by using images captured by CCTVs in New York. For example, the electronic apparatus 10 may identify cargo pants 150 as the second clothing, and obtain and display information about the cargo pants 150 on the display 21.

According to various embodiments, when the clothing trend database is stored in the external server, the electronic apparatus 10 may transmit the changed recommendation condition 110 to the server. The server may newly obtain the information about the second clothing matching the first clothing based on the changed recommendation condition 110, and transmit the newly obtained information to the electronic apparatus 10. The electronic apparatus 10 may display the received information about the second clothing on the display 21.

According to various embodiments, the electronic apparatus 10 may display the information about the first clothing and the second clothing matching the first clothing by using another electronic apparatus. For example, the electronic apparatus 10 may establish communication with the other electronic apparatus such as a smartphone or a tablet PC. The user may control operation of the electronic apparatus 10 by using an application program installed in the other electronic apparatus. In addition, the other electronic apparatus may display the information described in relation to Reference Numerals 1-c and 1-d of FIG. 1, on a display of the other electronic apparatus by using data (or information) received from the electronic apparatus 10.

As described above, according to an embodiment of the disclosure, the electronic apparatus 10 may adaptively recommend the second clothing matching the first clothing in response to a clothing recommendation condition changed by the user.

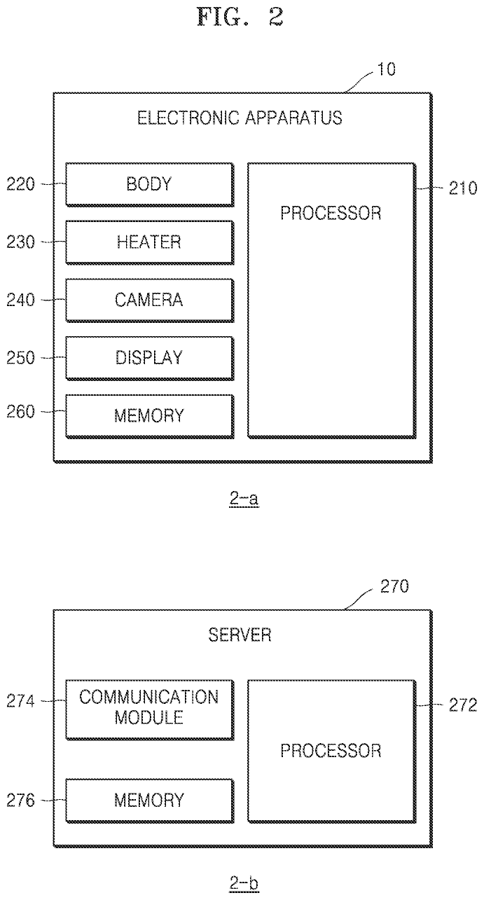

FIG. 2 is a block diagram of the electronic apparatus 10 according to an embodiment.

Referring to Reference Numeral 2-a of FIG. 2, the electronic apparatus 10 may include a processor 210, a body 220, a heater 230, a camera 240, a display 250, and a memory 260. However, the electronic apparatus 10 is not limited thereto. For example, the electronic apparatus 10 may further include elements to perform functions of the electronic apparatus 10, or may not include some elements. For example, the electronic apparatus 10 may further include a communication module (not shown) for establishing communication with an external apparatus. The display 250 may include the display 21 of FIG. 1.

According to an embodiment, the processor 210 may control overall operations of the electronic apparatus 10. For example, the processor 210 may control the memory 260 to execute a program stored in the memory 260, and read or store required information from or in the memory 260.

According to an embodiment, the processor 210 may control the camera 240 to generate a first clothing image by photographing first clothing introduced into a process room, obtain information about the first clothing by using the first clothing image, obtain information about second clothing matching the first clothing by using the information about the first clothing, control the display 250 to display the obtained information about the second clothing, and obtain and display information about second clothing different from the displayed second clothing in response to a user input for changing a second clothing recommendation condition.

According to an embodiment, the body 220 forms the exterior of the electronic apparatus 10. The body 220 may include an outer body provided outside, and an inner body provided inside the outer body to form the process room.

According to an embodiment, the process room may be a space for processing clothes introduced into the process room, e.g., a space for drying the clothes or eliminating wrinkles or odors of the clothes by applying hot air or steam to the clothes.

According to an embodiment, under the control of the processor 210, the heater 230 may suck in the air inside the process room, heat the air, and then blow the heated air into the process room, or receive water and provide hot air and steam into the process room.

According to an embodiment, under the control of the processor 210, the camera 240 may generate clothing images by photographing the clothes inside the process room.

According to an embodiment, the display 250 may display various contents. In addition, the display 250 may display an execution screen of an application program executed under the control of the processor 210. The display 250 may include a touchscreen display integrated with a touchscreen panel. The electronic apparatus 10 may execute an operation of the electronic apparatus 10 based on a user command input using the display 250.

According to an embodiment, the memory 260 may include at least one of flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disc, and an optical disc.

According to an embodiment, the memory 260 may store instructions to be executed by the processor 210 to control the camera 240 to generate the first clothing image by photographing the first clothing introduced into the process room, obtain the information about the first clothing by using the first clothing image, obtain the information about the second clothing matching the first clothing by using the information about the first clothing, control the display 250 to display the obtained information about the second clothing, and obtain and display the information about the second clothing different from the displayed second clothing in response to the user input for changing the second clothing recommendation condition.

According to an embodiment, the electronic apparatus 10 may cooperate with a server 270 to obtain the information about the second clothing.

Referring to Reference Numeral 2-b of FIG. 2, the server 270 may include a processor 272, a communication module 274, and a memory 276.

According to an embodiment, the processor 272 may control overall operations of the server 270. For example, the processor 272 may control the memory 276 to execute a program stored in the memory 276, and read or store required information from or in the memory 276.

According to an embodiment, the processor 272 may obtain the information about the first clothing through the communication module 274 from an external apparatus (e.g., the electronic apparatus 10), obtain information about second clothing matching the first clothing by applying the information about the first clothing to a clothing trend database, and control the communication module 274 to transmit the information about the second clothing to the external apparatus.

According to an embodiment, under the control of the processor 272, the communication module 274 may obtain the information about the first clothing from the external apparatus, and transmit the generated information about the second clothing to the external apparatus.

According to an embodiment, the memory 276 may store instructions configured to obtain the information about the first clothing through the communication module 274 from the external apparatus (e.g., the electronic apparatus 10), obtain the information about the second clothing matching the first clothing by applying the information about the first clothing to the clothing trend database, and control the communication module 274 to transmit the information about the second clothing to the external apparatus.

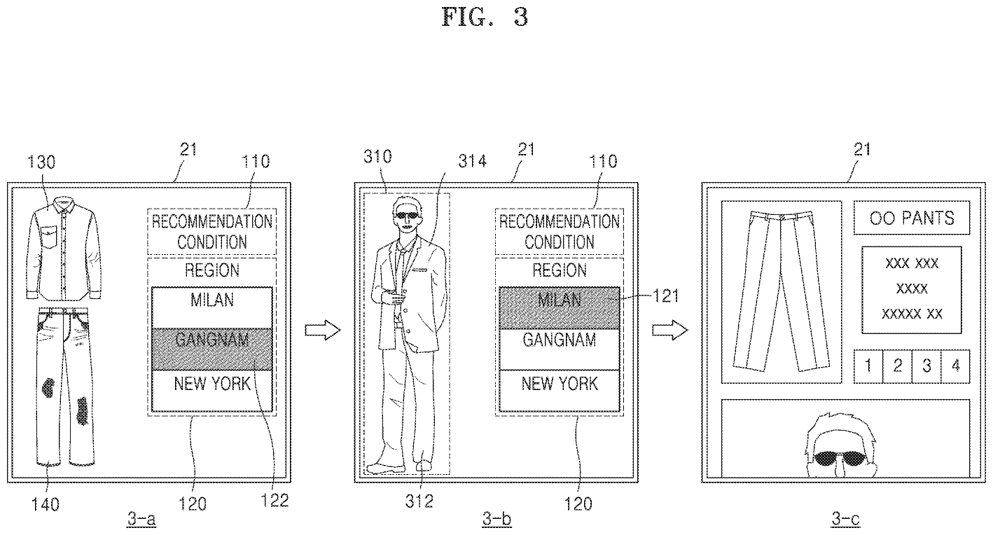

FIG. 3 is a diagram for describing another situation of recommending clothing by using the electronic apparatus 10 according to an embodiment.

Referring to Reference Numeral 3-a of FIG. 3, the electronic apparatus 10 may display a representative image of second clothing on the display 21 as information about the second clothing.

According to an embodiment, the electronic apparatus 10 may display, on the display 21, the recommendation condition 110 for obtaining the information about the second clothing. The recommendation condition 110 for obtaining the information about the second clothing may include at least one of, for example, a region where clothing is mainly consumed, a race, a color of clothing, a type of clothing, a brand of clothing, clothes owned by a user, and an age group who prefers clothing.

Referring to Reference Numeral 3-a of FIG. 3, the electronic apparatus 10 may identify the second clothing matching first clothing by setting “Gangnam” 122 as the region 120 used as a recommendation condition 110. For example, the electronic apparatus 10 may identify the jeans 140 as the second clothing matching the shirt 130 corresponding to the first clothing, and obtain and display information about the jeans 140 on the display 21.

According to an embodiment, the electronic apparatus 10 may identify the second clothing as the jeans 140 which are included in a large number of images including the shirt 130 corresponding to the first clothing, and obtain and display the information about the second clothing on the display 21. In this case, for example, the electronic apparatus 10 may identify the second clothing as the jeans 140 which are included in a large number of images including the shirt 130 corresponding to the first clothing, and display the jeans 140 on the display 21 from among clothing images previously captured and stored by the electronic apparatus 10 by photographing the clothes owned by the user.

According to an embodiment, the electronic apparatus 10 may display the image including the second clothing in response to a user input for changing the recommendation condition 110.

Referring to Reference Numeral 3-b of FIG. 3, the electronic apparatus 10 may receive a user input for changing the region 120 to “Milan” 121. The electronic apparatus 10 may display the image including the second clothing matching the first clothing on the display 21 based on the changed recommendation condition 110. For example, the electronic apparatus 10 may display, on the display 21, an image 310 including clothing that a large number of people wear in Milan or which is included in a large number of images posted on social media sites in Milan together with the shirt 130 corresponding to the first clothing. In this case, the second clothing may include, for example, pants 312 or a jacket 314.

According to various embodiments, the electronic apparatus 10 may display, on the display 21, a user interface for adjusting a price range. In this case, the electronic apparatus 10 may display the image including the second clothing matching the first clothing on the display 21 in response to a user input for changing the price range.

According to an embodiment, in response to a user input for selecting one of items of clothing included in the image 310, the electronic apparatus 10 may guide purchase of the selected item of clothing. For example, referring to Reference Numeral 3-b of FIG. 3, the electronic apparatus 10 may receive a user input for selecting the pants 312 from among the items of clothing included in the image 310 displayed on the display 21.

Referring to Reference Numeral 3-c of FIG. 3, the electronic apparatus 10 may display, on the display 21, an online shopping site selling the pants 312 selected by the user or pants similar to the pants 312.

As described above, according to an embodiment of the disclosure, the electronic apparatus 10 may provide an image including a plurality of items of second clothing to the user. In response to a user input for selecting one of items of clothing included in an image, the electronic apparatus 10 may provide information about an online shopping mall selling the selected item of clothing or an item similar to the selected item of clothing, thereby increasing user convenience.

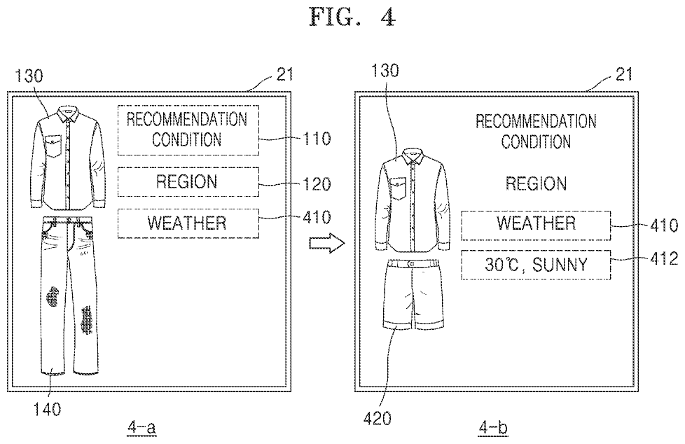

FIG. 4 is a diagram for describing a situation of using weather information to recommend clothing by using the electronic apparatus 10 according to an embodiment.

Referring to Reference Numeral 4-a of FIG. 4, the electronic apparatus 10 may display a representative image of second clothing on the display 21 as information about the second clothing.

According to an embodiment, the electronic apparatus 10 may display, on the display 21, the recommendation condition 110 for obtaining the information about the second clothing. The recommendation condition 110 for obtaining the information about the second clothing may include, for example, weather information. The weather information may be weather information of a region where a user is located, which is obtained and reflected to the recommendation condition 110 by the electronic apparatus 10.

Referring to Reference Numeral 4-a of FIG. 4, the electronic apparatus 10 may identify the second clothing before reflecting a weather 410 used as a recommendation condition 110. For example, the electronic apparatus 10 may identify the second clothing as the jeans 140 which are included in a large number of images including the shirt 130 corresponding to first clothing, and obtain and display the information about the second clothing on the display 21.

According to an embodiment, the electronic apparatus 10 may change and display the second clothing in response to a user input for changing the recommendation condition 110.

Referring to Reference Numeral 4-b of FIG. 4, the electronic apparatus 10 may receive a user input for selecting the weather 410. The electronic apparatus 10 may display weather information 412 on the display 21 in response to the user input. In addition, the electronic apparatus 10 may newly identify the second clothing matching the first clothing based on the added recommendation condition 110. For example, the electronic apparatus 10 may identify short pants 420 as the second clothing, and obtain and display information about the short pants 420 on the display 21.

According to various embodiments, the electronic apparatus 10 may recommend the second clothing by reflecting the weather of a region desired by the user. For example, the electronic apparatus 10 may provide a user interface for inputting weather information of a region other than the region where the user is currently located. The electronic apparatus 10 may change and display the second clothing by reflecting weather information of the region input using the user interface.

As described above, according to an embodiment of the disclosure, the electronic apparatus 10 may recommend the second clothing matching the first clothing by using weather information.

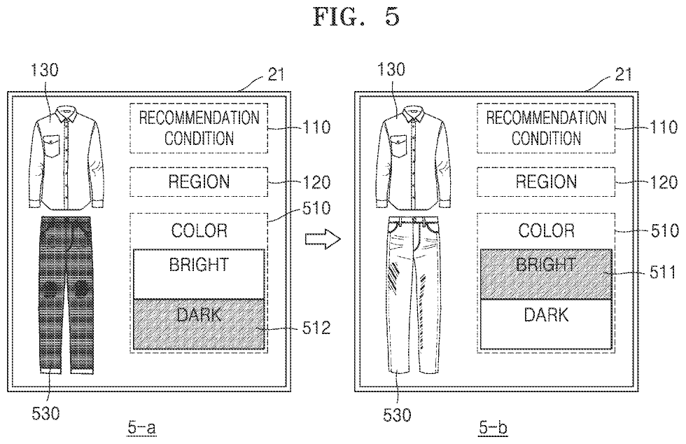

FIG. 5 is a diagram for describing a situation of using color information to recommend clothing by using the electronic apparatus 10 according to an embodiment.

Referring to Reference Numeral 5-a of FIG. 5, the electronic apparatus 10 may display a representative image of second clothing on the display 21 as information about the second clothing.

According to an embodiment, the electronic apparatus 10 may display, on the display 21, the recommendation condition 110 for obtaining the information about the second clothing. The recommendation condition 110 for obtaining the information about the second clothing may include at least one of, for example, a region where clothing is mainly consumed, a race, a color of clothing, a type of clothing, a brand of clothing, clothes owned by a user, and an age group who prefers clothing.

Referring to Reference Numeral 5-a of FIG. 5, the electronic apparatus 10 may identify the second clothing matching first clothing by setting “dark” 512 as a color 510 used as a recommendation condition 110. For example, the electronic apparatus 10 may identify dark jeans 530 as the second clothing matching the shirt 130 corresponding to the first clothing, and obtain and display information about the dark jeans 530 on the display 21.

According to an embodiment, the electronic apparatus 10 may change and display the second clothing in response to a user input for changing the recommendation condition 110.

Referring to Reference Numeral 5-b of FIG. 5, the electronic apparatus 10 may receive a user input for changing the color 510 to “bright” 511. The electronic apparatus 10 may newly identify the second clothing matching the first clothing based on the changed recommendation condition 110. For example, the electronic apparatus 10 may identify bright jeans 530 as the second clothing, and obtain and display information about the bright jeans 530 on the display 21.

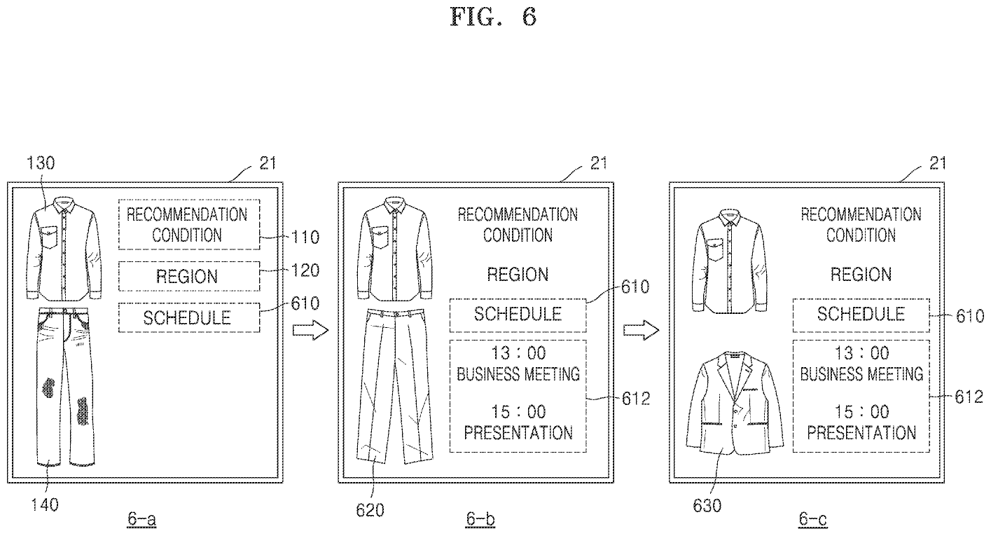

FIG. 6 is a diagram for describing a situation of using a personal schedule of a user to recommend clothing by using the electronic apparatus 10 according to an embodiment.

Referring to Reference Numeral 6-a of FIG. 6, the electronic apparatus 10 may display a representative image of second clothing on the display 21 as information about the second clothing.

According to an embodiment, the electronic apparatus 10 may display, on the display 21, the recommendation condition 110 for obtaining the information about the second clothing. The recommendation condition 110 for obtaining the information about the second clothing may include, for example, schedule information. The schedule information may be information obtained in association with another electronic apparatus of the user and reflected to the recommendation condition 110 by the electronic apparatus 10.

Referring to Reference Numeral 6-a of FIG. 6, the electronic apparatus 10 may identify the second clothing before reflecting schedule information used as a recommendation condition 110. For example, the electronic apparatus 10 may identify the second clothing as the jeans 140 which are included in a large number of images including the shirt 130 corresponding to first clothing, and obtain and display the information about the second clothing on the display 21.

According to an embodiment, the electronic apparatus 10 may change and display the second clothing in response to a user input for changing the recommendation condition 110.

Referring to Reference Numerals 6-b and 6-c of FIG. 6, the electronic apparatus 10 may receive a user input for selecting a schedule 610. The electronic apparatus 10 may display schedule information 612 on the display 21 in response to the user input. In addition, the electronic apparatus 10 may newly identify the second clothing matching the first clothing based on the added recommendation condition 110. For example, the electronic apparatus 10 may identify formal pants 620 as the second clothing, and obtain and display information about the formal pants 620 on the display 21. The electronic apparatus 10 may identify a jacket 630 as the second clothing, and obtain and display information about the jacket 630 on the display 21.

According to various embodiments, the electronic apparatus 10 may recommend the second clothing by reflecting a schedule selected by the user. For example, the electronic apparatus 10 may display, on the display 21, a user interface for selecting one of a plurality of displayed schedules. The electronic apparatus 10 may change and display the second clothing considering only the schedule selected using the user interface.

As described above, according to an embodiment of the disclosure, the electronic apparatus 10 may recommend the second clothing matching the first clothing by using schedule information.

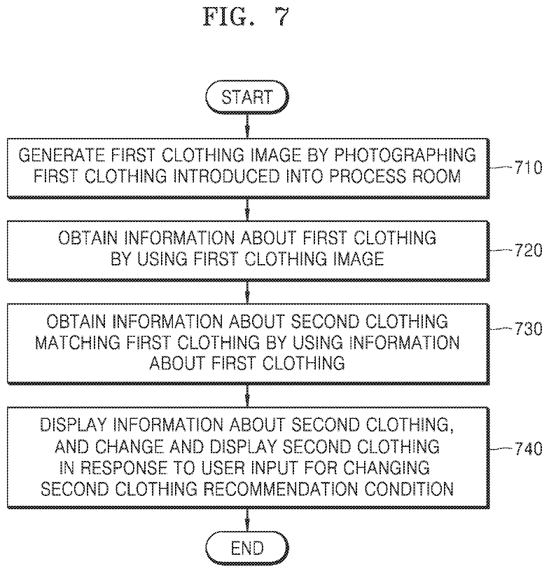

FIG. 7 is a flowchart for describing a situation where the electronic apparatus 10 according to an embodiment recommends clothing.

Referring to operation 710, the electronic apparatus 10 may generate a first clothing image by photographing first clothing introduced into a process room. For example, the electronic apparatus 10 may generate the first clothing image by photographing the first clothing by operating at least one camera included in the electronic apparatus 10 at a timing when a door is open and then closed.

Referring to operation 720, the electronic apparatus 10 may obtain information about the first clothing by using the first clothing image. For example, the electronic apparatus 10 may obtain the information about the first clothing by using a clothing trend database. Alternatively, the electronic apparatus 10 may obtain the information about the first clothing by using online search.

Referring to operation 730, the electronic apparatus 10 may obtain information about second clothing matching the first clothing by using the information about the first clothing. For example, the obtaining of the information about the second clothing matching the first clothing may refer to, for example, identifying the second clothing as clothing suitable for a user to wear with the first clothing, and obtaining information about the second clothing. Alternatively, the obtaining of the information about the second clothing matching the first clothing may refer to, for example, identifying the second clothing as clothing that the user is highly likely to wear with the first clothing, and obtaining information about the second clothing. Alternatively, the obtaining of the information about the second clothing matching the first clothing may refer to, for example, identifying the second clothing as clothing which is included in images including the first clothing, and obtaining information about the second clothing.

The information about the second clothing may include at least one of, for example, a representative image of clothing, a type of clothing, a brand of clothing, and a color of clothing.

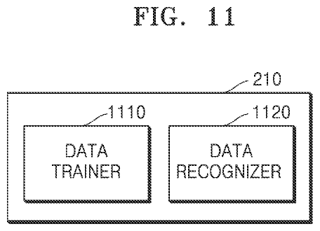

According to various embodiments, the electronic apparatus 10 may estimate the information about the second clothing by using a trained model to be described below in relation to FIG. 11. The trained model may be a model trained to estimate the information about the second clothing matching the first clothing by using the information about the first clothing. The trained model may be, for example, a model trained using clothing images and information about regions where the clothing images are captured.

Referring to operation 740, the electronic apparatus 10 may display the information about the second clothing, and change and display the second clothing in response to a user input for changing a second clothing recommendation condition. The second clothing recommendation condition for obtaining the information about the second clothing may include at least one of, for example, a region where clothing is mainly consumed, a color of clothing, a type of clothing, a brand of clothing, clothes owned by the user, and an age group who prefers clothing. However, the recommendation condition is not limited thereto.

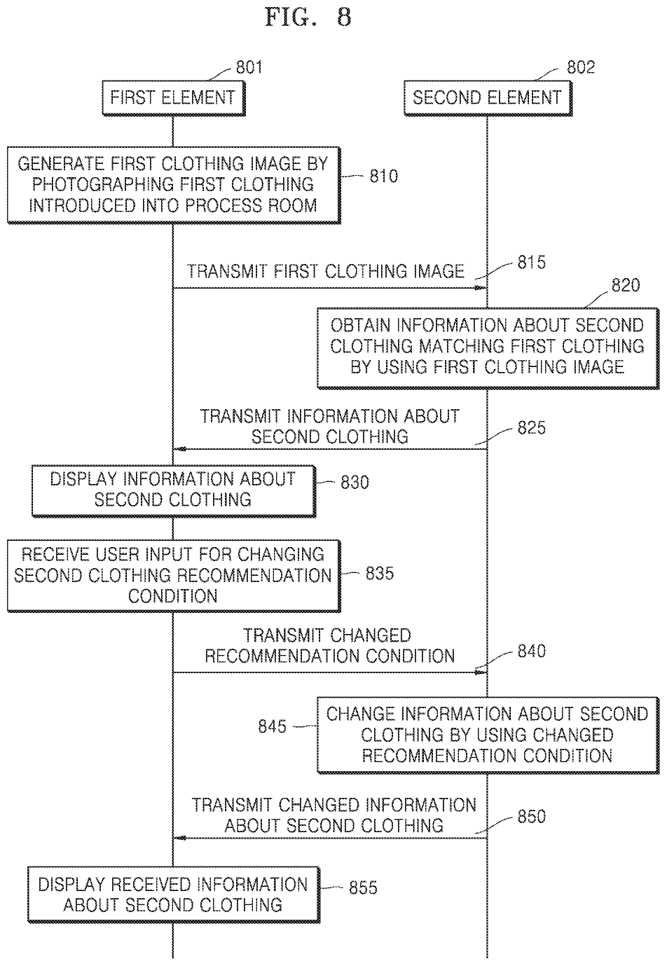

FIG. 8 is a flowchart for describing a situation where a first element 801 recommends clothing by using a second element 802.

In FIG. 8, the first element 801 may be the electronic apparatus 10, and the second element 802 may be a server having stored therein a trained model to be described below in relation to FIG. 11. Alternatively, the first element 801 may be a general-purpose processor, and the second element 802 may be a dedicated artificial intelligence (AI) processor. Alternatively, the first element 801 may be at least one application, and the second element 802 may be an operating system (OS).

That is, as an element that is more integrated, is dedicated, has less delay, has higher performance, or has more resources compared to the first element 801, the second element 802 may more rapidly and effectively process much calculation required to generate, refine, or apply the trained model compared to the first element 801.

According to various embodiments, a third element functioning similarly to the second element 802 may be added.

In this case, an interface for transmitting/receiving data between the first and second elements 801 and 802 may be defined.

For example, an application program interface (API) including factor values (or parameter values or transfer values) as training data to be applied to the trained model may be defined. The API may be defined as a set of subroutines or functions that can be called by any one protocol (e.g., a protocol defined in the electronic apparatus 10) for any process of another protocol (e.g., a protocol defined in the server). That is, the API may provide an environment where any one protocol may perform an operation of another protocol.

Referring to operation 810, the first element 801 may generate a first clothing image by photographing first clothing introduced into a process room. For example, the first element 801 may generate the first clothing image by photographing the first clothing by operating at least one camera included in the first element 801 at a timing when a door is open and then closed.

Referring to operation 815, the first element 801 may transmit the first clothing image to the second element 802.

Referring to operation 820, the second element 802 may obtain information about second clothing matching the first clothing by using the first clothing image. For example, the obtaining of the information about the second clothing matching the first clothing may refer to, for example, identifying the second clothing as clothing suitable for a user to wear with the first clothing, and obtaining information about the second clothing. Alternatively, the obtaining of the information about the second clothing matching the first clothing may refer to, for example, identifying the second clothing as clothing that the user is highly likely to wear with the first clothing, and obtaining information about the second clothing. Alternatively, the obtaining of the information about the second clothing matching the first clothing may refer to, for example, identifying the second clothing as clothing which is included in images including the first clothing, and obtaining information about the second clothing.

The information about the second clothing may include at least one of, for example, a representative image of clothing, a type of clothing, a brand of clothing, and a color of clothing.

According to various embodiments, the second element 802 may estimate the information about the second clothing by using the trained model to be described below in relation to FIG. 11. The trained model may be a model trained to estimate the information about the second clothing matching the first clothing by using information about the first clothing. The trained model may be, for example, a model trained using clothing images and information about regions where the clothing images are captured.

Referring to operation 825, the second element 802 may transmit the information about the second clothing to the first element 801.

Referring to operation 830, the first element 801 may display the information about the second clothing.

Referring to operation 835, the first element 801 may receive a user input for changing a second clothing recommendation condition. For example, the first element 801 may change the second clothing recommendation condition by selecting an item displayed on a display.

Referring to operation 840, the first element 801 may transmit the changed second clothing recommendation condition to the second element 802.

Referring to operation 845, the second element 802 may change the previously obtained information about the second clothing by using the changed second clothing recommendation condition.

Referring to operation 850, the second element 802 may transmit the changed information about the second clothing to the first element 801.

Referring to operation 855, the first element 801 may display the received information about the second clothing.

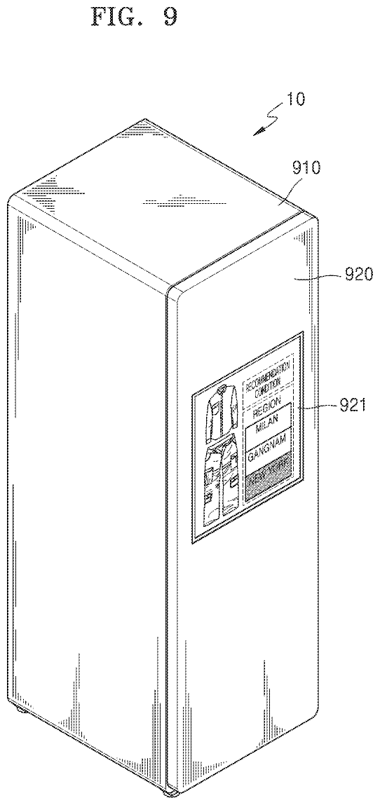

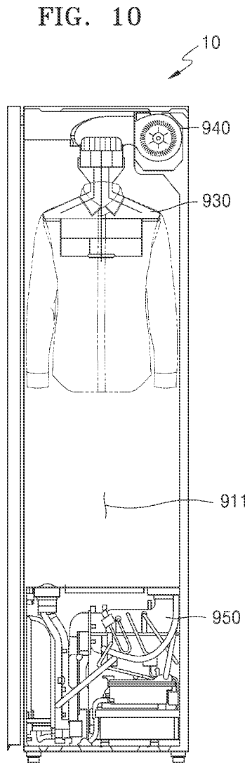

FIG. 9 is a perspective view of the electronic apparatus 10 according to an embodiment. FIG. 10 is a side cross-sectional view of the electronic apparatus 10 according to an embodiment.

Referring to FIGS. 9 and 10, the electronic apparatus 10 may include a body 910 for forming a process room 911 where clothes are placed and taken care of, a door 920 for opening or closing the process room 911, and clothes hangers 930 provided in the process room 911 to hang the clothes on. The door 920 may include the door 20 of FIG. 1. The process room 911 may include the process room 11 of FIG. 1.

The electronic apparatus 10 further includes an air blower 940 provided at an upper side of the body 910 to supply air into the process room 911, and a steam generator 950 provided at a lower side of the body 910 to generate steam to be supplied into the process room 911. Although not clearly shown in FIGS. 9 and 10, the body 910 may include refrigeration cycle elements for dehumidifying the clothes. Therefore, when the clothes are provided in the process room 911, dust and odors of the clothes may be eliminated by supplying the air generated by the air blower 940 into the process room 911, and wrinkles of the clothes may be reduced by supplying the steam generated by the steam generator 950 into the process room 911.

The door 920 may include a display 921 provided on a front surface of the door 920 to allow a user to control operation of the electronic apparatus 10. The display 921 may include the display 21 of FIG. 1. The display 921 may display a user interface for allowing the user to control operation of the electronic apparatus 10, and an operating status of the electronic apparatus 10. In addition, the display 921 may display clothing recommended to the user as described above.

FIG. 11 is a block diagram of the processor 210 according to an embodiment.

Referring to FIG. 11, the processor 210 according to an embodiment may include a data trainer 1110 and a data recognizer 1120.

According to an embodiment, the data trainer 1110 may train a model to have criteria for estimating information about second clothing matching first clothing. The data trainer 1110 may train the model to have criteria for training data to be used to estimate the information about the second clothing matching the first clothing, or for how to estimate the information about the second clothing by using the training data.

The data trainer 1110 may train the model by using, as the training data, clothing images and information about regions where the clothing images are captured. For example, the training data may include clothing images captured by CCTVs in Gangnam, and information indicating that the clothing images are captured in Gangnam. Alternatively, the training data may include clothing images captured by CCTVs in Milan, and information indicating that the clothing images are captured in Milan.

According to an embodiment, the data recognizer 1120 may estimate the information about the second clothing matching the first clothing by applying recognition data to the trained model. The data recognizer 1120 may obtain certain recognition data according to criteria that are preset through training, and estimate the information about the second clothing by using the obtained recognition data as an input value of the trained model. In addition, the information about the second clothing, which is estimated by the trained model by using the recognition data as the input value, may be used to refine the trained model.

The data recognizer 1120 may estimate second clothing information matching a first clothing image by applying the first clothing image to the trained model as the recognition data. For example, the data recognizer 1120 may estimate a shirt that can match pants in Gangnam by applying, to the trained model, a clothing image obtained by photographing the pants.

At least one of the data trainer 1110 and the data recognizer 1120 may be produced in the form of at least one hardware chip and be mounted in the electronic apparatus 10. For example, at least one of the data trainer 1110 and the data recognizer 1120 may be produced in the form of a dedicated AI hardware chip, or be produced as a part of an existing general-purpose processor (e.g., CPU or application processor) or a dedicated graphic processor (e.g., a graphics processing unit (GPU)) and be mounted in any of various electronic apparatuses.

According to an embodiment, the dedicated AI hardware chip is a dedicated processor that is specialized for probability calculation, and may rapidly perform calculation in the field of AI, e.g., machine learning, due to a higher processing performance compared to the existing general-purpose processor.

In this case, the data trainer 1110 and the data recognizer 1120 may be mounted in a single electronic apparatus 10, or in different electronic apparatuses. For example, one of the data trainer 1110 and the data recognizer 1120 may be included in the electronic apparatus 10, and the other may be included in the server 270. The data trainer 1110 may be connected to the data recognizer 1120 in a wired or wireless manner such that data of the model trained by the data trainer 1110 may be provided to the data recognizer 1120 and data input to the data recognizer 1120 may be provided to the data trainer 1110 as additional training data.

Meanwhile, at least one of the data trainer 1110 and the data recognizer 1120 may be implemented as a software module. When at least one of the data trainer 1110 and the data recognizer 1120 is implemented as a software module (or a program module including instructions), the software module may be stored in non-transitory computer readable media. In this case, at least one software module may be provided by an operating system (OS) or by a certain application. Alternatively, a part of at least one software module may be provided by an OS, and the other part may be provided by a certain application.

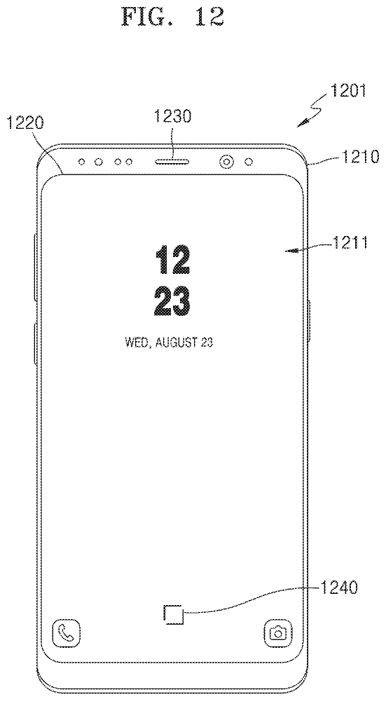

FIG. 12 is a schematic diagram of another electronic apparatus 1201 according to an embodiment.

Referring to FIG. 12, the other electronic apparatus 1201 according to an embodiment of the disclosure may include a housing 1210, a display 1220, or a speaker 1230. However, the other electronic apparatus 1201 is not limited thereto. The other electronic apparatus 1201 may be implemented as various apparatuses such as a laptop computer, a tablet PC, a desktop computer, an e-book reader, a digital broadcast receiver, a PDA, a PMP, an MP3 player, and a wearable device, etc.

The housing 1210 may provide a space for mounting an element (e.g., the display 1220 or the speaker 1230). The housing 1210 may be implemented in various forms.

The display 1220 may be located on a front surface 1211 of the housing 1210. The display 1220 may be provided as a touchscreen integrated with a touch panel. According to an embodiment, the display 1220 may include a curved surface. For example, the display 1220 may include a curved surface in edge regions adjacent to corners.

According to an embodiment, the speaker 1230 for outputting a sound signal may be located above the display 1220 provided on the front surface 1211 of the housing 1210. A home key 1240 may be provided in the form of a soft key on a lower area of the display 1220. However, the form of the home key 1240 is not limited thereto. For example, the other electronic apparatus 1201 may place a physical key serving as a home key on an area of a front surface of the other electronic apparatus 1201.

According to an embodiment, the other electronic apparatus 1201 may mount, in the vicinity of the speaker 1230, components for performing various functions. According to an embodiment, the components may include at least one sensor module. For example, the components may include at least one of an ambient light sensor (e.g., an optical sensor), a proximity sensor, an infrared sensor, or an ultrasonic sensor. According to an embodiment, the components may include a light-emitting diode (LED) indicator to provide status information of the other electronic apparatus 1201 to a user.

According to an embodiment, the other electronic apparatus 1201 may establish communication with the electronic apparatus 10 and perform the above-described procedure described in relation to FIG. 1, 3, 4, 5, or 6 by using the display 1220 included in the other electronic apparatus 1201.

Various embodiments of the disclosure may be implemented as software including one or more instructions stored in a storage medium (e.g., embedded memory or external memory) readable by a machine (e.g., the electronic apparatus 10). For example, a processor (e.g., the processor 210) of the machine (e.g., the electronic apparatus 10) may call at least one of the stored one or more instructions from the storage medium, and execute the same. As such, the machine may be operated to perform at least one function based on the called at least one instruction. The one or more instructions may include codes generated by a compiler or codes executable by an interpreter. The storage medium readable by the machine may be provided in the form of a non-transitory storage medium. When the storage medium is ‘non-transitory’, it merely means that the storage medium is tangible and does not include signals (e.g., electromagnetic waves), and it does not limit that data is semi-permanently or temporarily stored in the storage medium.

The method according to various embodiments of the disclosure may be included and provided in a computer program product. The computer program product may be traded between a seller and a buyer. The computer program product may be distributed in the form of a machine-readable storage medium (e.g., a compact disc read only memory (CD-ROM)), or be electronically distributed (e.g., downloaded or uploaded) via an application store (e.g., Play Store™) or directly between two user devices (e.g., smartphones). For electronic distribution, at least a part of the computer program product may be at least temporarily stored in a machine-readable storage medium such as a memory of a server of a manufacturer, a server of an application store, or a relay server, or be temporarily created.

According to various embodiments, each of the above-mentioned elements (e.g., modules or programs) may include one or more entities. According to various embodiments, one or more of the above-mentioned elements or operations thereof may be omitted, or one or more other elements or operations may be added. Alternatively or additionally, a plurality of elements (e.g., modules or programs) may be integrated into one element. In this case, the integrated element may perform one or more functions equally or similarly to those of each of the plurality of elements before being integrated. According to various embodiments, operations performed by modules, programs, or other elements may be carried out sequentially, in parallel, repeatedly, or heuristically, or one or more of the operations may be performed in a different order or be omitted, or one or more other operations may be added.

1. An electronic apparatus comprising:
a body for providing a process room where clothes are placed;
a heater for supplying at least one of hot air and steam into the process room;
at least one camera for photographing an inside of the process room;
a display;
a processor; and
a memory,
wherein the memory stores instructions to be executed by the processor to:
control the camera to generate a first clothing image by photographing first clothing introduced into the process room;
obtain information about the first clothing by using the first clothing image;
obtain information about second clothing matching the first clothing by using the information about the first clothing;
control the display to display the obtained information about the second clothing; and
obtain and display information about second clothing different from the displayed second clothing in response to a user input for changing a second clothing recommendation condition.

2. The electronic apparatus of claim 1, wherein the information about the first clothing and the information about the second clothing comprise at least one of a representative image of clothing, a type of clothing, a brand of clothing, and a color of clothing.

3. The electronic apparatus of claim 1, wherein the memory stores further instructions to be executed by the processor to:
identify the second clothing matching the first clothing by using a clothing trend database stored in the electronic apparatus; and
obtain information about the identified second clothing.

4. The electronic apparatus of claim 3, wherein the clothing trend database is generated using at least one of clothing images or clothing data comprised in online fashion magazines, clothing images or clothing data comprised in social media, and images obtained using closed-circuit televisions (CCTVs) located in various regions.

5. The electronic apparatus of claim 1, further comprising:
a communication module,
wherein the memory stores further instructions to be executed by the processor to:
control the communication module to obtain weather information; and
change and display the second clothing in response to a user input for applying the weather information as the second clothing recommendation condition.

6. The electronic apparatus of claim 1, further comprising:
a communication module,
wherein the memory stores further instructions to be executed by the processor to:
control the communication module to obtain schedule information of a user; and
change and display the second clothing in response to a user input for applying the schedule information as the second clothing recommendation condition.

7. The electronic apparatus of claim 1, wherein the memory stores further instructions to be executed by the processor to obtain the information about the second clothing matching the first clothing by using clothing images previously captured using the camera and stored into the electronic apparatus.

8. The electronic apparatus of claim 1, wherein the memory stores further instructions to be executed by the processor to display an image comprising clothing equal or similar to the first clothing, and an image comprising the second clothing.

9. A method of controlling an electronic apparatus, the method comprising:
generating a first clothing image by photographing first clothing;
obtaining information about the first clothing by using the first clothing image;
obtaining information about second clothing matching the first clothing by using the information about the first clothing;
displaying the information about the second clothing; and
obtaining and displaying information about second clothing different from the displayed second clothing in response to a user input for changing a second clothing recommendation condition.

10. The method of claim 9, further comprising:
identifying the second clothing matching the first clothing by using a clothing trend database stored in the electronic apparatus; and
obtaining information about the identified second clothing.

11. The method of claim 9, further comprising:
obtaining weather information; and
changing and displaying the second clothing in response to a user input for applying the weather information as the second clothing recommendation condition.

12. The method of claim 9, further comprising:
obtaining schedule information of a user; and
changing and displaying the second clothing in response to a user input for applying the schedule information as the second clothing recommendation condition.

13. The method of claim 14, further comprising:
obtaining the information about the second clothing matching the first clothing by using clothing images previously captured using a camera and stored into the electronic apparatus.

14. The method of claim 9, further comprising:
displaying an image comprising clothing equal or similar to the first clothing, and an image comprising the second clothing.

15. A non-transitory computer-readable recording medium having recorded thereon a computer program for executing the method of claim 9.
